(19) United States
(12) Patent Application Publication
(10) Pub. No.: US 2014/0121870 A1
(43) Pub. Date: May 1, 2014

(54) SYSTEM FOR CONTROLLING E-4WD HYBRID ELECTRICITY VEHICLE AND METHOD THEREOF

(71) Applicant: HYUNDAII MOTOR COMPANY, Seoul (KR)

(72) Inventor: Minsu Lee, Seoul (KR)

(73) Assignee: HYUNDAI MOTOR COMPANY, Seoul (KR)

(21) Appl. No.: 13/707,059

(22) Filed: Dec. 6, 2012

(30) Foreign Application Priority Data
Oct. 26, 2012 (KR) 10-2012-0119950

(51) Int. Cl. B60W 20/00

(52) U.S. Cl. CPC B60W 20/10; Y10S 903/902
USPC 701/22; 477/3; 903/902; 180/65.21; 180/65.22

(57) ABSTRACT

Disclose is a control system of an E-4WD hybrid electric vehicle that includes a first controller that controls a first driving portion disposed on a front axle and a second driving portion disposed on a rear axle. A second controller is connected to the first controller and configured to maintain a predetermined target speed. A third controller controls a braking torque through the first controller and the fourth controller detects/monitors conditions in front of the vehicle and performs deceleration through the third controller. A fifth controller controls the driving torque of a motor system. In particular, the first controller distributes driving torque for realizing a target deceleration/acceleration value based on the deceleration/acceleration information of the second controller and the fourth controller to the first driving portion and the second driving portion to control a driving torque and a regenerative braking torque thereof.

### CROSS-REFERENCE TO RELATED APPLICATION

This application claims priority to and the benefit of Korean Patent Application No. 10-2012-0119950 filed in the Korean Intellectual Property Office on Oct. 26, 2012, the entire contents of which are incorporated herein by reference.

### BACKGROUND

(a) Field of the Invention

The present invention relates to a control system of a hybrid electric vehicle and the method thereof. More particularly, the present invention relates to a control system of an electric four wheel drive (E-4WD) hybrid electric vehicle that optimally controls a driving torque and a regenerative braking force of a front axle and a rear axle according to the deceleration and the acceleration speed information and the method thereof.

(b) Description of the Related Art

Generally, an E-4WD hybrid electric vehicle includes driving wheels that are independently controlled, and the driving wheels are respectively driven or are braked. Hybrid electric vehicles can include both electric vehicles and the fuel cell vehicles which use two different sources of power to provide a driving torque.

The E-4WD hybrid electric vehicle in most cases operates in a 2 wheel drive mode in which either a front axle or a rear axle is supplied power, and may be engaged in a 4 wheel drive mode when the driving torque is necessary either automatically (i.e., by detecting slip) or manually by input on the part of the driver. E-4WD hybrid electric vehicles, therefore, can apply an engine and a motor system to a front axle or a rear axle.

For example, the engine may be applied to the front axle, and the independent motor system may be applied to the rear axle. Also, an in wheel motor system may be applied to either the front axle or the rear axle, and an in-wheel motor system can be applied to the other axle.

E-4WD hybrid electric vehicles use a driving force from the motor system during take off and acceleration, and the output torque is generated by the engine and the motor system, wherein the output torque ratio of the engine and the motor system is controlled accordingly.

Generally, the engine of the front axle and the motor system of the rear axle respectively generate a driving force with a fixed ratio therebetween. This fixed ratio uses electrical energy inefficiently.

The E-4WD hybrid electric vehicle may also include a smart cruise control (SCC) system and an anti pre collision system (APCS) to provide convenience and safety to a driver. These functions are often operated by a Hybrid Control Unit (HCU).

The hybrid control unit (HCU) accelerates or decelerates the vehicle via control signals that are transmitted from the SCC and APCS. For example, when the acceleration demand signal is transmitted from the SCC, the hybrid control unit (HCU) determines a necessary target torque and then controls the output of the engine that is mounted on the front axle. In this case, if it is determined that the front drive wheel is slipping on the road, the motor system that is disposed at a rear axle is operated.

Also, when the deceleration demand order is transmitted from the APCS, the hybrid control unit (HCU) determines a necessary target braking force and then generates a braking hydraulic pressure through a safety control apparatus (ESC).

Accordingly, when the driving torque and the braking force are controlled by the deceleration and acceleration demand that is transmitted from the SCC and the APCS, the driving torque and braking torque are not suitably distributed between the engine of the front axle and the motor system of the rear axle such that the overall energy is inevitably lost.

The above information disclosed in this Background section is only for enhancement of understanding of the background of the invention and therefore it may contain information that does not from the prior art that is already known in this country to a person having ordinary skill in the art.

### SUMMARY

The present invention has been made in an effort to provide a control system of a hybrid electric vehicle and the method thereof having advantages of suitably distributing torque to a front axle and a rear axle depending on demand from the smart cruise control and the anti pre collision system to reduce fuel consumption.

The present invention efficiently distributes driving torque to a front axle and a rear axle when a driving demand signal is transmitted from the SCC when a driver does not intervene therein. The present invention, also efficiently distributes braking torque to a front wheel and a rear wheel when a braking demand is transmitted from the APCS when a driver does not intervene therein so that regenerative braking efficiency is improved.

A control system of an E-4WD hybrid electric vehicle according to an exemplary embodiment of the present invention may include a hybrid control unit that controls a first driving portion that is disposed on and operably connected to a front axle and a second driving portion that is disposed on operably connected to a rear axle, a cruise driving unit (e.g., second controller) that is connected to the hybrid control unit (e.g., first controller) configured to maintain the vehicle at a predetermined target speed, a safety control unit (e.g., third controller) configured to control hydraulic pressure braking force through the hybrid control unit, a collision prevention unit (e.g., fourth controller) that is configured to detect and monitor conditions in front of a vehicle and performs a deceleration through the safety control unit if certain conditions are detected, a power control unit (e.g. fifth controller) that is configured to control the driving torque of a motor system that is disposed on at least one side of the first driving portion and the second driving portion, wherein the hybrid control unit distributes the driving torque for realizing a target deceleration/acceleration value based on the deceleration/acceleration information of the cruise driving unit and the collision prevention unit to the first driving portion and the second driving portion to control a driving torque and a regenerative braking force thereof.

When a driving demand is detected from the cruise driving unit, the hybrid control unit may be configured to determine a target acceleration, calculate an entire driving torque, detect a vertical load of each wheel and the slip thereof, determine a torque ratio having a maximum efficiency point from a predetermined efficiency map, and distribute the driving torque to the first driving portion and the second driving portion, accordingly.

Furthermore, when a braking demand is detected from the collision prevention unit, the hybrid control unit may be configured to determine a target deceleration, calculate an entire braking torque, calculate a regenerative braking torque according to a vehicle speed, a motor condition, and a deceleration, select a maximum efficiency point from a predetermined efficiency map, and distribute the regenerative braking torque to the first driving portion and the second driving portion.

When the regenerative braking torque is less than the entire braking torque, a battery is fully charged, or the battery is broken, the hybrid control unit may also be configured to perform hydraulic pressure braking through the safety control unit.

The first driving portion may be one of an engine, a motor system that is connected to a front axle, or an in-wheel motor system that may be disposed in a front left/right wheel, and the second driving portion may be one of a motor system that is connected to a rear axle, or an in-wheel motor system that is disposed in a rear left/right wheel. Preferably, however, the first driving portion is an engine and the second driving portion is an in wheel motor system, the first driving portion is an engine and the second driving portion is an in-wheel motor system, the first driving portion is an in-wheel motor system and the second driving portion is an in wheel motor system, or the first driving portion and the second driving portion is an in-wheel motor system.

A control method of an E-4WD hybrid electric vehicle according to an exemplary embodiment of the present invention may include detecting, by a controller, a vehicle speed, a vehicle weight, a vertical load of each driving wheel, and a slip rate of each driving wheel, determining, by the controller, whether the information received by a cruise driving unit and a collision prevention unit is braking or driving information, determining, by the controller, a target acceleration to calculate an entire driving torque, analyzing, by the controller, a vertical load and a slip of each driving wheel, determining, by the controller, a torque ratio which has a maximum efficiency point from a predetermined efficiency map, and distributing the driving torque to the first driving portion and the second driving portion when a driving demand is detected from the cruise driving unit, and determining a target deceleration to calculate and entire braking torque, calculating a regenerative braking torque according to the vehicle speed, a motor condition, and the deceleration, determining a braking condition having a maximum efficiency point from a predetermined efficiency map, and distributing the regenerative braking torque to the first driving portion and the second driving portion, when a braking demand is detected from the collision prevention unit.

Furthermore, when the regenerative braking torque that is determined by the braking demand of the collision prevention unit is less than the entire braking torque, a battery is fully charged, or the battery is broken, the hybrid control unit performs a hydraulic pressure braking through the safety control unit.

As described above, the present invention suitably distributes driving torque to a front wheel and a rear wheel to improve driving safety and reduce energy consumption when a driver does not intervene in the E-4WD hybrid electric vehicle. to Also, the present invention efficiently distributes braking torque to a front wheel and a rear wheel to improve regenerative braking efficiency when a driver does not intervene in the E-4WD hybrid electric vehicle.

### BRIEF DESCRIPTION OF THE DRAWINGS

FIG. 1 schematically shows a control system of an E-4WD hybrid electric vehicle according to an exemplary embodiment of the present invention.

FIG. 2 is a flowchart schematically showing a control process of an E-4WD hybrid electric vehicle according to an exemplary embodiment of the present invention.

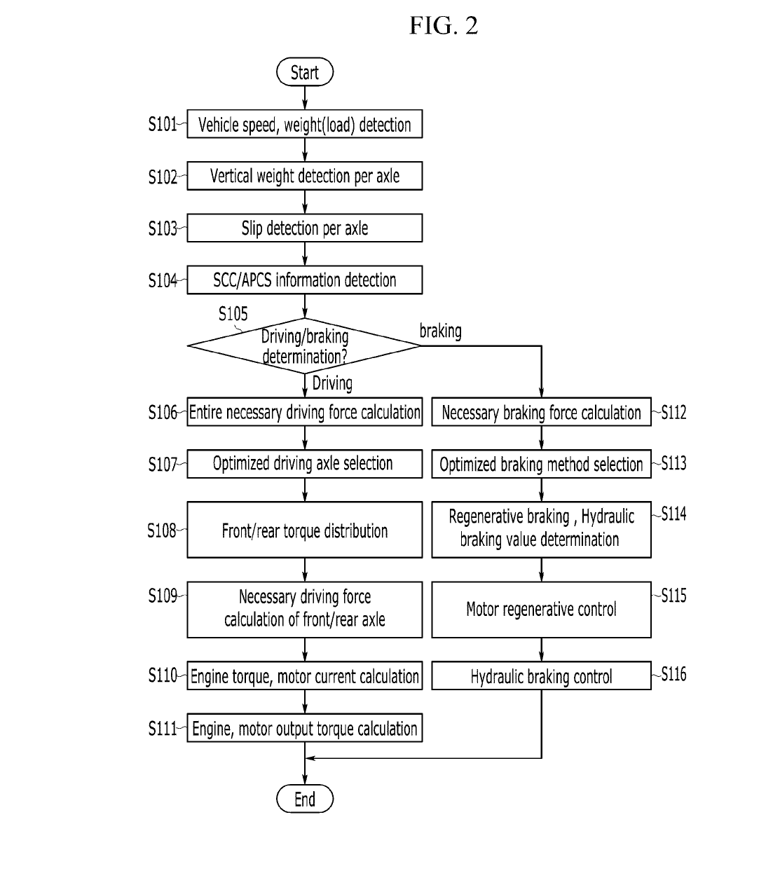

FIG. 3 schematically shows a control system of an E-4WD hybrid electric vehicle in which an engine and an in-wheel motor are applied according to an exemplary embodiment of the present invention.

FIG. 4 schematically shows a control system of an E-4WD hybrid electric vehicle in which an in-wheel motor and an in-line motor system are applied according to an exemplary embodiment of the present invention.

FIG. 5 schematically shows a control system of an E-4WD hybrid electric vehicle in which an in-wheel motor system is applied according to an exemplary embodiment of the present invention.

### DETAILED DESCRIPTION OF THE EMBODIMENTS

Hereinafter, the present invention will be described more fully hereinafter with reference to the accompanying drawings, in which exemplary embodiments of the invention are shown.

As those skilled in the art would realize, the described embodiments may be modified in various different ways, all without departing from the spirit or scope of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Additionally, it is understood that the below methods are executed by at least one controller. The term controller refers to a hardware device that includes a memory and a processor. The memory is configured to store the modules and the processor is specifically configured to execute said modules to perform one or more processes which are described further below. Furthermore, although the exemplary embodiment is described as including a plurality of controllers/control units that execute a plurality of functions, these functions may all be executed by a singular controller without departing form the illustrative embodiment of the present invention.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

In order to clarify the present invention, parts that are not connected with the description will be omitted, and the same elements or equivalents are referred to by the same reference numerals throughout the specification.

Also, the size and thickness of each element are arbitrarily shown in the drawings and the present invention is not necessarily limited thereto, and in the drawings, the thickness of layers, films, panels, regions, etc., are exaggerated for clarity.

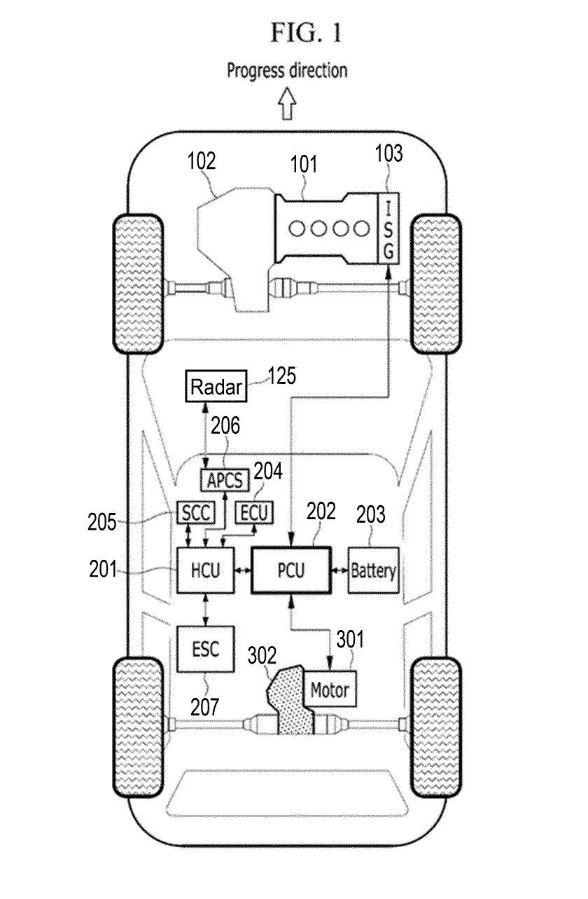

FIG. 1 schematically shows a control apparatus of an E-4WD hybrid electric vehicle according to an exemplary embodiment of the present invention. Referring to FIG. 1, the first exemplary embodiment of the present invention includes an engine 101 as a power source of a front wheel, a transmission 102 that is connected to an output shaft of the engine 101, and a first driving portion that includes an ISG (idle stop and generator 103) for starting or turning off the engine 101 depending on the driving condition and that operates as a generator during normal operation.

The motor system operating as a second driving portion is disposed in FIG. 1 as a power source for the rear wheels of the vehicle and the output of the motor 301 is transferred to left/right side operating wheels through a differential gear 302.

The first driving portion and the second driving portion are controlled (connected) by a hybrid control unit (HCU) 201 (e.g., first controller), a power control unit (PCU) 202 (e.g., fifth controller), a battery 203, an engine controller (ECU) 204 (e.g., sixth controller), a cruise driving device (SCC) 205 (e.g., second controller), a collision prevention device (e.g., fourth controller) (APCS: anti pre collision system) 206, and a safety control apparatus (e.g., third controller) 207 (preferably an Electronic Stability Controller (ESC), and the above elements are connected with each other through communication line or network.

Without the driver intervening, the hybrid control unit (HCU; 201) may be configured to determine a target deceleration value and a target acceleration value based on deceleration/acceleration information that is transferred from the cruise driving device (SCC; 205) and the collision prevention device (APCS; 206), calculate an entire braking torque or an driving torque based on the target deceleration/acceleration value, and distribute the braking torque or the driving torque to the front wheels and the rear wheels to suitably control the driving torque and the regenerative braking torque.

While the driver does not intervene, when the information that is transmitted from the cruise driving device (SCC; 205) is a driving demand, the hybrid control unit (HCU; 201) may be configured to determine a target acceleration value, calculate an entire driving torque that would realize the target acceleration, detect a vertical load of the driving wheels and a slip thereof to determine a torque ratio having an optimized efficiency point, and distribute the driving torque to the driving wheels so that the energy consumption is minimized.

Also while the driver does not intervene, when the information that is transmitted from the collision prevention device (APCS; 206) is a braking demand/information, the hybrid control unit (HCU; 201) may be configured to determine a target deceleration value, calculate an entire braking torque which would realize the target deceleration based on a vehicle speed, a motor condition, and a deceleration speed to determine a braking condition that would have an optimized efficiency, and distribute the braking torque to the driving wheels so that the regenerative braking of the motor consumption is maximized.

When the regenerative braking torque is less than the target braking force, the battery 203 is fully charged, or the battery 203 is broken, the hybrid control unit (HCU; to 201) performs a hydraulic pressure braking through the safety control apparatus (ESC; 207).

The power control unit (PCU; 202) may include a motor controller and an inverter, and be configured to convert a high DC voltage (e.g., 200V to 450V) that is supplied from the battery 203 to 3 phase AC voltage based on the control signal from the hybrid control unit (HCU; 201) to supply the AC voltage to the motor 301. The power control unit (PCU; 202) may also operate the ISG 103 of the first driving portion that is applied to a front axle based on the control signal from the hybrid control unit (HCU; 201) to start the engine 101, and may also charge the battery 203 by applying the voltage that is supplied from the ISG 103 that is operated by the engine 101. The power control unit (PCU; 202) may also charge the battery 203 by the voltage that is generated from the motor 301 through a regenerative braking control during braking. The DC voltage of about 200 to 450V that is charged in the battery 203 may used to drive the motor 301 that is applied to a rear axle. Likewise, the engine control apparatus (ECU; 204) may control the output of the engine 101 based on the control from the hybrid control unit (HCU; 201).

Without driver intervention, the cruise driving device (SCC; 205) may be configured to maintain the vehicle at a predetermined target speed.

During this uniform speed (i.e., due to control by the cruise driving device), the collision prevention device (APCS; 206) detects/monitors conditions in front of the vehicle via (e.g, a radar device 125), and when, e.g., a pedestrian or another vehicle is detected within a predetermined distance, a deceleration demand signal is output to prevent the collision of the vehicle with an obstacle (e.g., a pedestrian or another vehicle).

The safety control apparatus (ESC; 207) may also generate a hydraulic pressure to braking force based on receiving a control signal that is transmitted from the hybrid control unit 201.

Hereinafter, the functions of the present invention will be described as follows:

While an E-4WD hybrid electric vehicle operating in a cruise control mode at a predetermined target speed, the hybrid control unit (HCU; 201), may be configured to detect a vehicle speed and a vehicle weight S101, calculate a vertical load of each wheel S102, and detect slip of the drive wheel S103.

The hybrid control unit (HCU; 201) analyzes the information that is transmitted from the cruise driving device (SCC; 205) and the collision prevention device (APCS; 206) through a communication line or a network S104 and determines whether a demanded condition is driving or braking S105.

When the driving demand is detected from the cruise driving device (SCC; 205) in S105, the hybrid control unit (HCU; 201) may determine a target acceleration value, and may calculate an entire driving torque based on the target acceleration value in S106. The hybrid control unit (HCU; 201) may also analyze the vertical load of each driving wheel and the slip thereof, apply an efficiency map of the engine and the motor to determine an optimized driving wheel having a highest efficiency point in a S107, and determine a torque ratio between the front axle and the rear axle to distribute the driving torque to them S108.

Afterwards, in S109, the hybrid control unit 201 may then control the output torque of the engine 101 as a first driving portion that is applied to a front axle through the engine control apparatus (ECU; 204), and control the output torque of the motor 301 forming in-wheel motor system as a second driving portion that is applied to a rear axle through PCU 202 S110 so that the energy consumption is minimized S111.

Also, when a braking demand is detected from the collision prevention device (APCS; 206) in S105, the hybrid control unit (HCU; 201) determines a target deceleration and calculates a braking force based on the target deceleration S112. The hybrid control unit (HCU; 201) determines a braking condition which has the highest efficiency point and a max regenerative braking torque based on a vehicle speed, a motor condition, and a deceleration, distributes the regenerative braking torque to the front axle and the rear axle, and determines an optimized braking method S113 accordingly.

Afterwards, the hybrid control unit (HCU; 201) determines a regenerative braking control value and a hydraulic pressure braking control value S114, when the regenerative braking satisfies the target deceleration, performs the regenerative braking control of the motor 301 to maximize the regenerative braking amount so that the battery 203 is efficiently charged S115.

However, the hybrid control unit (HCU; 201) may operate the safety control apparatus (ESC; 207), when the regenerative braking amount is lower than the braking force, the battery 203 is fully charged, or the battery 203 is broken, and performs the hydraulic pressure braking S116.

As described above, without the intervention of the driver, when the cruise driving device demands a driving torque for a target acceleration, an entire torque is calculated based on the target acceleration, a torque ratio between a front axle and a rear axle having an optimized efficiency point is determined/identified, and the torque is distributed to an independent driving portion corresponding to the front axle and the rear axle so that the energy efficiency is optimized.

Also, without the intervention of a driver, when it is determined that the information of the collision prevention device demands braking, an entire braking torque that would realize the target deceleration is calculated, the regenerative braking torque is determined to have an optimized efficiency point, and the regenerative braking of the motor system is performed so that the battery is effectively charged.

When the battery is fully charged, the battery is broken, or the regenerative braking torque is not enough to realize the target deceleration, hydraulic pressure braking may also be applied to improve the stability of the braking.

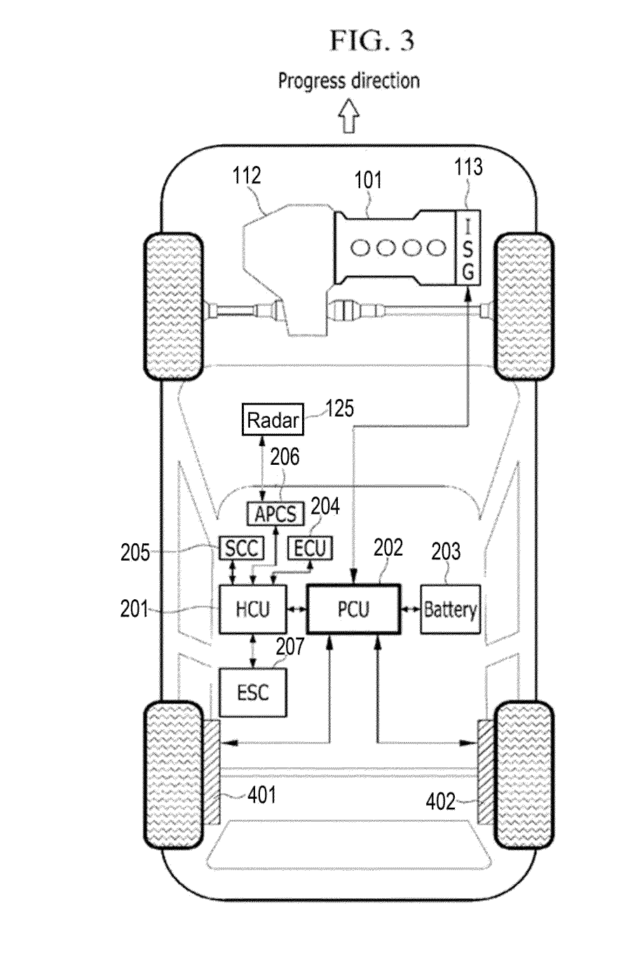

In the above description, it is described that an engine is applied to a front axle as a first driving portion, and an in-line motor system is applied to a rear axle as a second driving portion in the E-4WD hybrid electric vehicle. However, as shown in FIG. 3, when an engine 111 as a power source, a transmission 112 that is connected to the output shaft of the engine 111, and an ISG 113 that turns off or turns on the engine 111 are applied to a front axle as a first drive portion and each in-wheel motor 401 and 402 are disposed at a left and a right drive wheel of a rear axle as a second drive portion in the present invention, the driving torque and the braking torque is equally or similarly distributed according to the present invention.

The operation of the E-4WD hybrid electric vehicle having the configuration of the FIG. 3 is equal or similar to that of the FIG. 1, and therefore the detailed description thereof will be omitted.

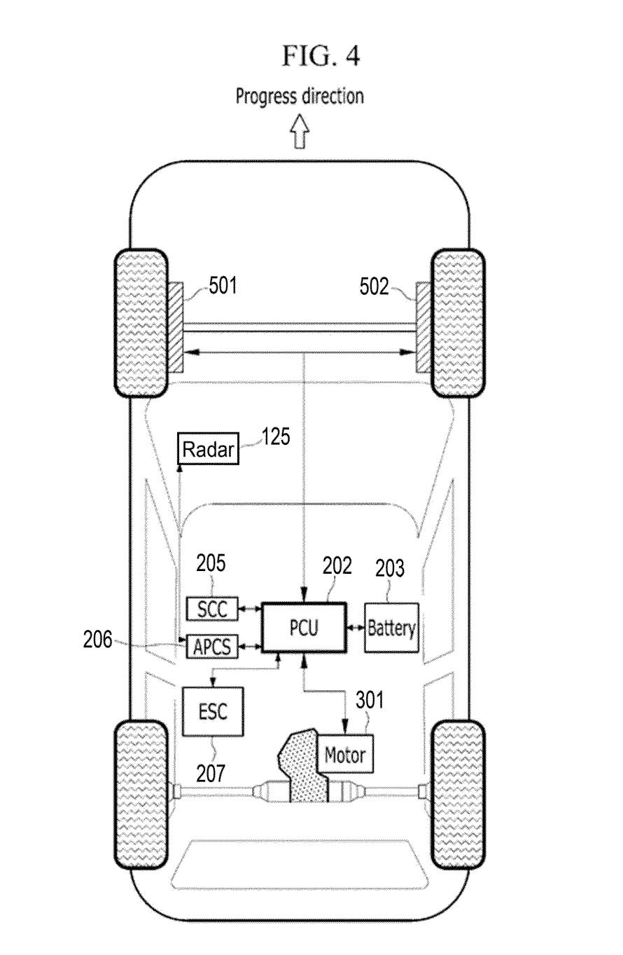

Also, as shown in FIG. 4, when each in-wheel motor 501, 502 is applied to a right and a left drive wheels as a first drive portion and in-line motor system is disposed at a rear axle as a second drive portion for the E-4WD hybrid electric vehicle, the driving torque and the braking torque is equally or similarly distributed according to the present invention. As can be seen from FIG. 4, the HCU 201 and the ECU 204 has been removed and SCC 205, APCS 206 are in direct communication with the PCU 202.

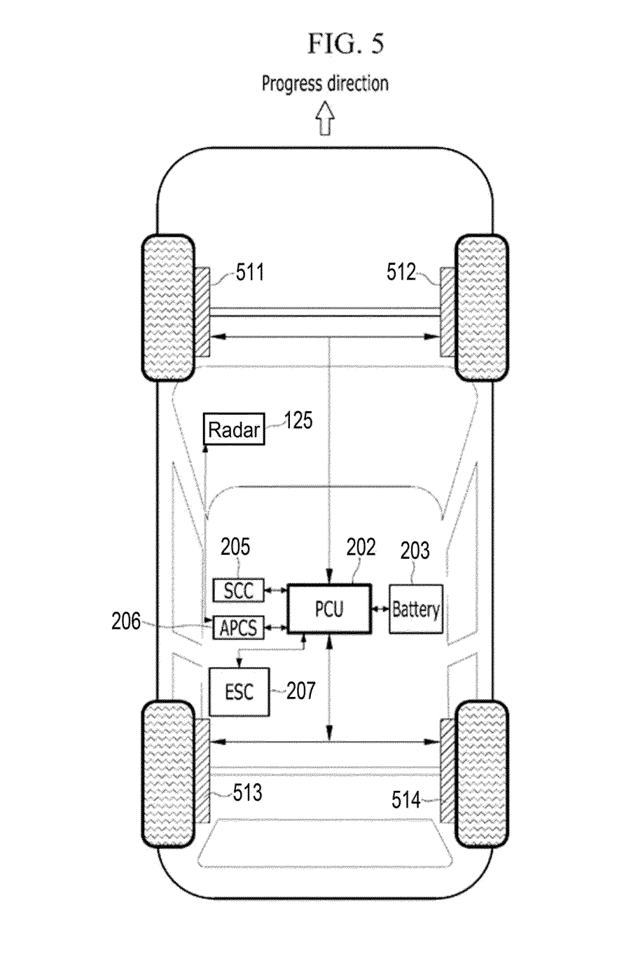

Also, as shown in FIG. 5, when each in-wheel motor 511, 512 are applied to a right and a left drive wheels as a first drive portion and each in-wheel motor 513, 514 is disposed at a rear axle as a second drive portion for the E-4WD hybrid electric vehicle, the driving torque and the braking torque is equally or similarly distributed according to the present invention. Again, as can be seen from FIG. 5, the HCU 201 and the ECU 204 has been removed and SCC 205, APCS 206 are in direct communication with the PCU 202.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A control system of an electric four wheel drive (E-4WD) hybrid electric vehicle, comprising:
a first controller configured to control a first driving portion that is disposed on a front axle and a second driving portion that is disposed on a rear axle;
a second controller connected to the first controller and configured to maintain the vehicle at a predetermined target speed;
a third controller configured to control hydraulic pressure braking torque through the first controller;
a fourth controller configured to detect and monitor an area in front of the vehicle and induce deceleration through the third controller;
a fifth controller configured to control the driving torque of a motor system that is disposed on at least one side of the first driving portion or the second driving portion,
wherein the first controller is configured to distribute the driving torque that would realize a target deceleration/acceleration value based on the deceleration/acceleration information of the second controller and the third controller to the first driving portion and the second driving portion to control a driving torque and a regenerative braking torque thereof,
wherein when a driving demand is detected from the second controller, the first controller determines a target acceleration, calculates an entire driving torque, detects a vertical load of each wheel and the slip thereof, determines a torque ratio which would have a maximum efficiency point from a predetermined efficiency map, and distributes the driving torque to the first driving portion and the second driving portion.

2. (canceled)

3. The control system of the E-4WD hybrid electric vehicle of claim 1, wherein when a braking demand is detected from the fourth controller, the first controller determines a target deceleration, calculates entire braking torque, calculates a regenerative braking torque according to a vehicle speed, a motor condition, and a deceleration, selects a maximum efficiency point from a predetermined efficiency map, and distributes the regenerative braking torque to the first driving portion and the second driving portion.

4. The control system of the E-4WD hybrid electric vehicle of claim 3, wherein when the regenerative braking torque is less than the entire braking torque, a battery is fully charged, or the battery is broken, the hybrid control unit performs a hydraulic pressure braking through the third controller.

5. The control system of the E-4WD hybrid electric vehicle of claim 1, wherein the first driving portion is one of an engine, a motor system that is connected to a front axle, or an in-wheel motor system that is disposed in a front left/right wheel, and
the second driving portion is one of a motor system that is connected to a rear axle, or an in-wheel motor system that is disposed in a rear left/right wheel.

6. The control system of the E-4WD hybrid electric vehicle of claim 1, wherein
the first driving portion is an engine and the second driving portion is an in-line motor system.

7. The control system of the E-4WD hybrid electric vehicle of claim 1, wherein the first driving portion is an engine and the second driving portion is an in-wheel motor system.

8. The control system of the E-4WD hybrid electric vehicle of claim 1, wherein the first driving portion is an in-wheel motor system and the second driving portion is an in-line motor system.

9. The control system of the E-4WD hybrid electric vehicle of claim 1, wherein the first driving portion and the second driving portion is an in-wheel motor system.

10. A control method of an electric four wheel drive (E-4WD) hybrid electric vehicle, comprising:
detecting, a first controller, a vehicle speed, a vehicle weight, a vertical load of each driving wheel, and a slip rate of each driving wheel;
determining, by the first controller, whether the information from a second controller and a fourth controller is a braking or a driving demand information;
determining, by the first controller, a target acceleration to calculate an entire driving torque;
analyzing, by the first controller, a vertical load and a slip of each driving wheel;
determining, by the first controller, a torque ratio which would have maximum efficiency point from a predetermined efficiency map;
distributing, by the first controller, the driving torque to a first driving portion disposed on a front axle and a second driving portion disposed on a rear axle when a driving demand is detected by the second controller;
determining, by the first controller, a target deceleration to calculate an entire braking torque;
calculating, by the first controller, a regenerative braking torque according to a vehicle speed, a motor condition, and a deceleration;
determining, by the first controller, a braking condition that would have a maximum efficiency point from a predetermined efficiency map, and
distributing, by the first controller, the regenerative braking torque to the first driving portion and the second driving portion, when a braking demand is detected by a fourth controller.

11. The control method of the E-4WD hybrid electric vehicle of claim 10, wherein when the regenerative braking torque that is determined by the braking demand of the fourth controller is less than the entire braking torque, a battery is fully charged, or the battery is broken, the hybrid control unit performs a hydraulic pressure braking through a third controller.

12. A control system of an electric four wheel drive (E-4WD) hybrid electric vehicle including an independent driving portion applied to front wheels and rear wheels respectively, comprising;
a hybrid control unit configured to control the independent driving portion of the front wheel and the rear wheel;
a cruise driving unit configured to realize a uniform speed along a predetermined target speed and detecting when a driving demand occurs;
a safety control unit configured to control a hydraulic pressure braking; and
a collision prevention unit configured to detect a front condition to prevent the collision through the safety control unit wherein the hybrid control unit is configured to distribute a driving torque that would realize a target deceleration/acceleration value based on deceleration/acceleration information of the cruise driving unit and the safety control unit to a first driving portion disposed on a front axle and a second driving portion disposed on a rear axle to control a driving torque and a regenerative braking torque thereof,
wherein when a driving demand is detected by the cruise driving unit, the hybrid control unit is further configured to determine a target acceleration, calculate an entire driving torque, detect a vertical load of each wheel and the slip thereof, determine a torque ratio which would have a maximum efficiency point from a predetermined efficiency map, and distribute the driving torque to the first driving portion and the second driving portion.
